(19) United States
(12) Patent Application Publication
(10) Pub. No.: US 2025/0190023 A1
(43) Pub. Date: Jun. 12, 2025

(54) FLEXIBLE ELECTRONIC DEVICE

(71) Applicant: PanelSemi Corporation, New Taipei City (TW)

(72) Inventor: Chen-Hsun YANG, New Taipei City (TW)

(21) Appl. No.: 18/977,318

(22) Filed: Dec. 11, 2024

Related U.S. Application Data
(60) Provisional application No. 63/608,566, filed on Dec. 11, 2023.

(51) Int. Cl. G06F 1/16

(52) U.S. Cl. CPC G06F 1/1652; G06F 1/1656

(57) ABSTRACT

A flexible electronic device capable of rolling or bending about an axis so that it can transform between a rolled state and an extended state. The flexible electronic device includes an electronic structure and a support structure. The electronic structure has a first surface and a second surface opposite to the first surface. The support structure has a third surface and a fourth surface opposite to each other. The third surface is connected with the second surface. The support structure defines a first direction parallel to the direction of the axis and defines a second direction perpendicular to the first surface. The second surface of the support structure includes a plurality of ribs parallel to the first direction, and a groove is formed between any two adjacent ribs. Each groove defines an open end and a closed end in the second direction.

### CROSS REFERENCE TO RELATED APPLICATIONS

This Non-provisional application claims priority to U.S. provisional patent application with Ser. No. 63/608,566 filed on Dec. 11, 2023. This and all other extrinsic materials discussed herein are incorporated by reference in their entirety.

### BACKGROUND

### Technology Field

The present disclosure relates to an electronic device and, in particular, to an flexible electronic device that can be rolled-up and unrolled.

### Description of Related Art

### BACKGROUND

### Technology Field

In recent years, flexible display technology has gradually become an important R&D trend of display technology due to its advantages of light and thin structure, rollable structure, small space occupation, easy to carry and good impact resistance. However, due to the weak ability of the flexible display device to resist external forces, when the bending amplitude of the flexible display device is excessive or the repeated bending is excessive, the part of the flexible display device itself that bears the greatest stress is prone to permanent deformation and separation or dislocation from other structures, thereby damaging the overall mechanical structure or electrical performance of the flexible display device. Therefore, it is an important issue to provide a flexible display device that can maintain both bendability and structural stability.

### SUMMARY

One or ones of the exemplary embodiments of this disclosure are to provide a flexible electronic device which maintains both bendability and structural stability.

A flexible electronic device, capable of rolling or bending about an axis, includes an electronic structure and a support structure. The electronic structure has a first surfaces and a second surface opposite to each other. The support structure has a third surface and a fourth surface opposite to each other, and the third surface of the support structure bonds to the second surface of the electronic structure. The support structure defines a first direction parallel to the axis, a second direction perpendicular to the first direction and parallel to the third surface, and a third direction perpendicular to the third surface; the fourth surface of the support structure has a plurality of protrusions spaced along the second direction and parallel to the first direction, and a plurality of grooves formed between two adjacent protrusions; one or ones of the grooves, along the third direction, defines an open end and a closed end. As the flexible electronic device is rolled or bent to a minimum radian about the axis, a shortest distance from the axis to the close end of the groove is defined as R1. As the flexible electronic device is rolled or bent to a minimum radian about the axis and the adjacent two protrusions are in the closest state, each of the two adjacent protrusions defines a closest point, in which a straight-line distance between the two closest points is the shortest distance between the two adjacent protrusions as the flexible electronic device is rolled or bent to the minimum radian; a shortest distance from the axis to one of the closest point as the flexible electronic device is rolled or bent to a minimum radian is defines as R2, and a shortest distance between the two adjacent closest point is defined as W1 while the flexible electronic device is in a non-rolled and non-bent state. As the flexible electronic device is rolled or bent, defines an corresponding angle of the roll part or the bent part thereof to the axis as θ degrees, and a quantity of the protrusions located in the rolled part or bent part of the support structure is N, satisfying the following condition: W1*N≥2*π*(R1−R2)*θ/360°.

The present invention also provides a flexible electronic device, capable of rolling or bending about an axis, includes an electronic structure and a support structure. The electronic structure has a first surfaces and a second surface opposite to each other. The support structure has a third surface and a fourth surface opposite to each other, and the third surface of the support structure bonds to the second surface of the electronic structure. The support structure defines a first direction parallel to the axis, a second direction perpendicular to the first direction and parallel to the third surface, and a third direction perpendicular to the third surface; the fourth surface of the support structure has a plurality of protrusions spaced along the second direction and parallel to the first direction, and a plurality of grooves formed between two adjacent protrusions; one or ones of the grooves, along the third direction, defines an open end and a closed end. As the flexible electronic device is rolled or bent into a minimum radian about the axis, defines a radius of curvature of the third surface located in the rolled part or bent part of the support structure as R3, and defines a radius of curvature of the closed end of the groove(s) located in the rolled part or bent part of the support structure as R4, satisfying the following condition: R4≥R3/3.

In one embodiment, as the flexible electronic device is rolled or bent to a minimum radian about the axis and the adjacent two protrusions are in the closest state, defines the straight-line distance (also the shortest distance) between the two closest points of the two adjacent protrusions as W2, and W2≥0.

In one embodiment, the support structure further includes a base layer between the electronic structure and the plurality of the protrusions.

In one embodiment, the base layer is a metal foil.

In one embodiment, the flexible electronic device further includes an adhesion layer between the electronic structure and the support structure.

In one embodiment, as the flexible electronic device is in a rolled or bent state, the closed end of the groove can be a curved surface convex toward to the open end 341 and defines a height, and a thickness of the adhesion layer is greater than the height h of the curved surface.

In one embodiment, the electronic structure is a display panel.

In one embodiment, the display panel comprises a supporting layer and a plurality of display units, one side of the supporting layer connects to the support structure, and the plurality of the display units spliced and arranged along another side of the supporting layer opposite the support structure.

In one embodiment, one or ones of the display unit comprises a base substrate, at least one signaling layer, a plurality of optoelectronic elements, and one or ones of driving structure; the signaling layer is arranged on or in the base substrate, the plurality of optoelectronic elements are arranged on the base substrate and electrically connected to the signaling layer, and the one or ones of the driving structures are electrically connected to the signaling layer and the plurality of the optoelectronic elements; wherein the signaling layer can be a signaling patterned layer.

In one embodiment, the material(s) of the base layer and the material(s) of the protrusions are the same.

In one embodiment, the material(s) of the base layer and the material(s) of the protrusions are different.

In one embodiment, one row of the protrusions comprises one ore ones subunits.

In one embodiment, a row of the protrusion is constituted by plural subunits.

In one embodiment, the electronic structure defines a thickness d, and at least one of the plurality of the grooves defines a depth h, satisfying the following: 3*d≥h1.

In one embodiment, the flexible electronic device further including an additional layer binding to a side of the plurality of the protrusion opposite to the third surface of the support structure and sealing the open ends of the plurality of the grooves; wherein the additional layer can be an additional film.

In one embodiment, the plurality of the grooves are provided with electrical materials or flexible materials therein.

In one embodiment, the flexible electronic device takes the axis as a central axis, and the fourth surface of the support structure faces to the axis as the flexible electronic device rolls about the axis into a rolled state.

In one embodiment, the flexible electronic device takes the axis as a central axis, and the first surface of the electronic structure faces to the axis as the flexible electronic device rolls about the axis into a rolled state.

In one embodiment, a process to manufacture the support structure comprises: placing a sheet material on the second surface (bottom surface) of the electronic structure and forming or arranging a plurality of grooves or protrusions on a surface of the sheet material opposite to the second surface of the electronic structure.

In one embodiment, the support structure is a multi-layered structure.

In one embodiment, the flexible electronic device can be transformed between a rolled state and an extended state.

Accordingly, the flexible electronic device of this invention is capable rolling about the axis, so the flexible electronic device can be transformed between a rolled state and an extent state; the flexible electronic device comprises an electronic structure and a support structure; the electronic structure has a first surface (outer surface) and a second surface (bottom surface) opposite to each other; the support structure has a third surface and a fourth surface opposite to each other, and the third surface of the support structure bonds to the second surface of the electronic structure. The support structure defines a first direction parallel to the axis, a second direction parallel to the third surface, and a third direction perpendicular to the third surface; the fourth surface of the support structure has a plurality of protrusions spaced along the second direction and parallel to the first direction, and a plurality of grooves formed between two adjacent protrusions; one or ones of the grooves defines an open end and a closed end along the third direction. The flexible electronic device 10 of the present invention enables the supporting structure 30 to provide better structural stability by the design of the protrusion 33 and the channel 34 and retains the bendability at the time, and reduces the risk of structural separation or dislocation, thereby preventing the damage of the flexible electronic device when rolling or bending.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing a flexible electronic device in an extended state of one embodiment of this disclosure;

FIG. 1B to FIG. 1F are sectional diagrams of embodiments of this disclosure;

FIG. 1G is a partial-enlarged diagram of FIG. 1F;

FIG. 1H is a schematic diagram showing different aspects of the protrusions of the flexible electronic device;

FIG. 2A and FIG. 2B are schematic diagrams of this disclosure in different rolled states;

FIG. 3A and FIG. 3B are two other schematic diagrams of this disclosure;

FIG. 4A and FIG. 4B are schematic diagrams showing changes in structure as this disclosure is in a rolled state;

FIG. 5A and FIG. 5B are schematic diagrams showing changes in structure as this disclosure is in a rolled state;

FIG. 6A and FIG. 6B are schematic diagrams showing changes in structure as this disclosure is in a rolled state;

FIG. 7A and FIG. 7B are schematic diagrams showing changes in structure as this disclosure is in a rolled state;

FIG. 8A and FIG. 8B are schematic diagrams showing changes in structure as this disclosure is in a rolled state;

FIG. 9 is a schematic diagram showing change in structure as this disclosure is in a rolled state; and

FIG. 10A and FIG. 10B are schematic diagrams of this disclosure in use.

### DETAILED DESCRIPTION OF THE DISCLOSURE

The disclosure will become more fully understood from the detailed description and accompanying drawings, which are given for illustration only, and thus are not limitative of the present disclosure.

It should be noted that each of the embodiments of this invention represents a combination of all elements disclosed in a possible case, but this invention may nevertheless be construed as including all possible combinations of the components it discloses. For example, if one embodiment includes elements A, B, and C, and a second embodiment includes elements B and D, this invention should cover multiple embodiments obtained from the permutation and combination of A, B, C and D, or obtained from the permutation and combination of these elements and other elements, even it is not clearly disclosed. The illustrative term such as “first” and “second” and other ordinal numbers are used for illustrative purposes only and do not indicate or imply relative order, importance, or the quantity of technical features. In the description of this invention, unless otherwise described, the meaning of “plurality” or “plural” includes two or more than two. The illustrative term such as “comprising”, “including” or other synonyms do not preclude the presence or addition of one or more other features in the absence of a contrary description. The spatially relative terms “above”, “below”, “left side”, “right side”, “parallel with” and “perpendicular to” are used herein for ease of description to describe the relations between one element or component and another element or component as illustrated in the drawings. The illustrative terms “connect”, “bond”, and other synonyms includes direct and indirect connections in the absence of a contrary description.

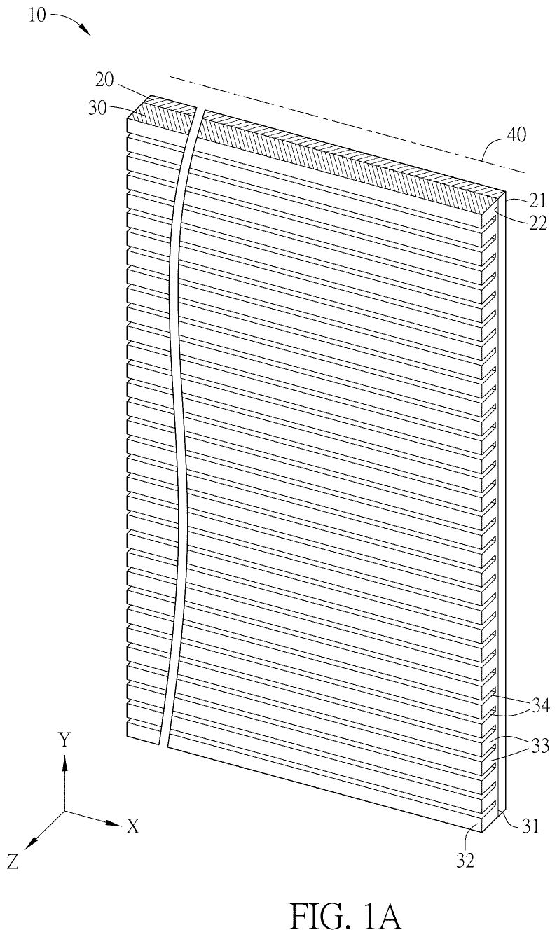

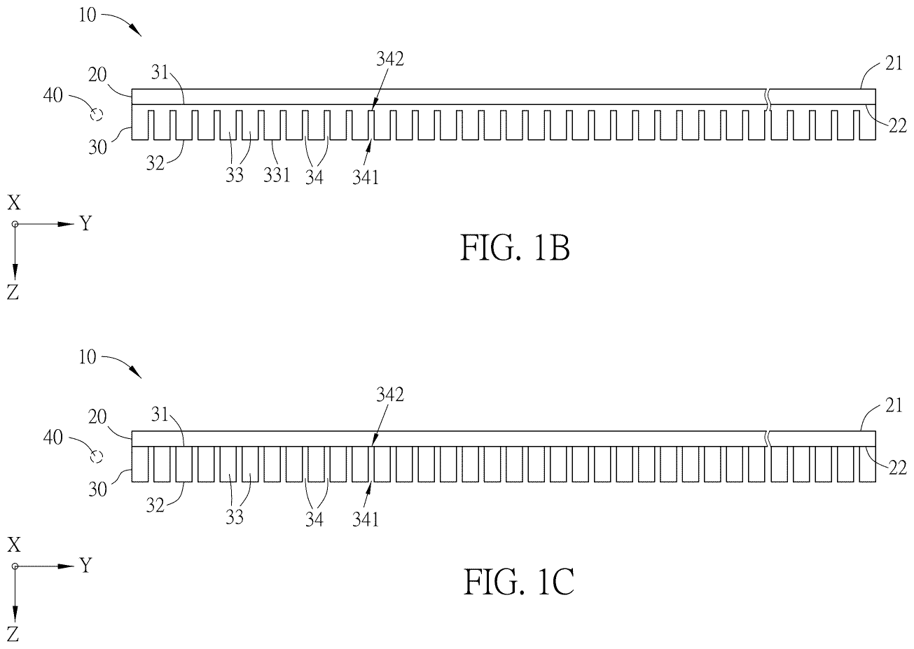

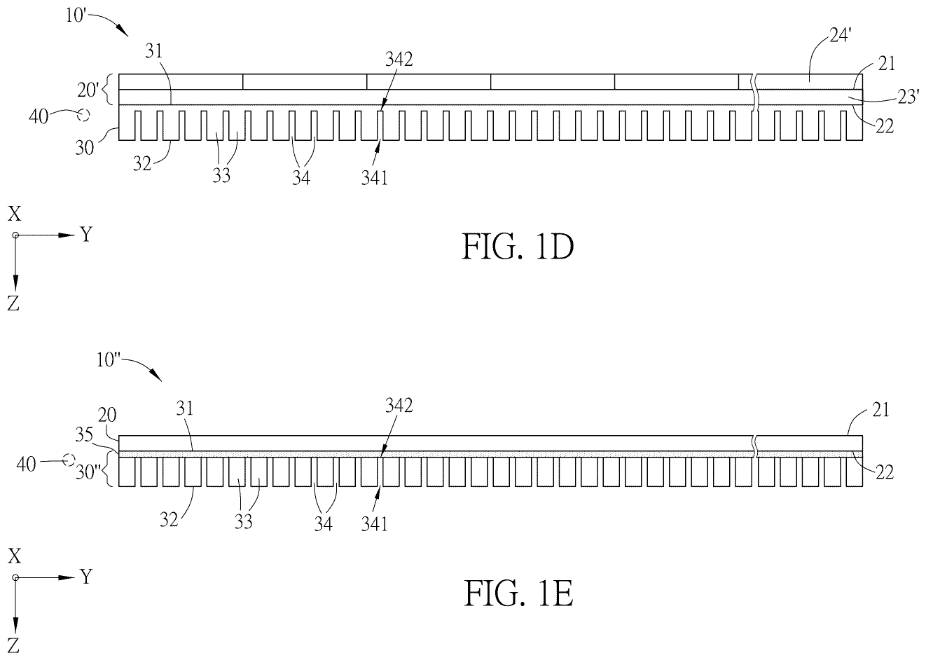

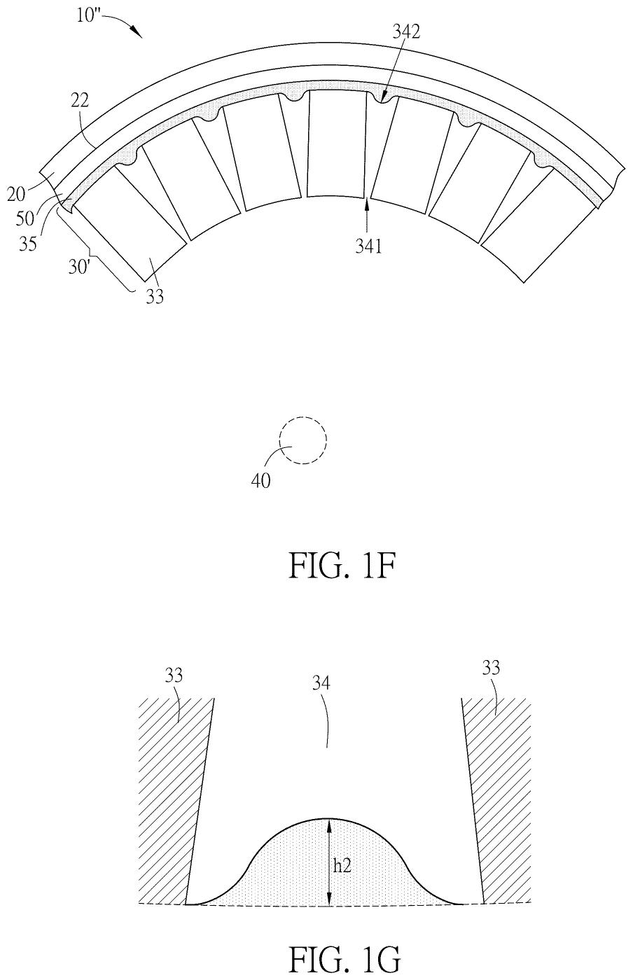

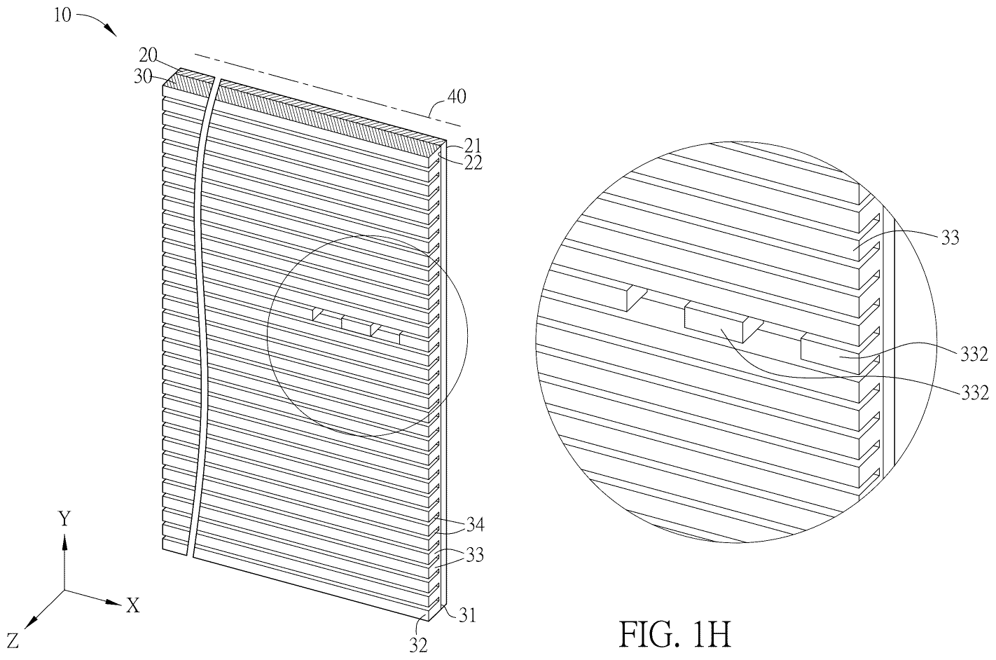

Referring to FIG. 1A and FIG. 1B, respectively shows a schematic diagram of the flexible electronic device 10 of this invention in an extended state, and a section diagram of the flexible electronic device 10 in FIG. 1A.

As shown in FIG. 1A and FIG. 1B, the flexible electronic device 10 of in this embodiment includes an electronic structure 20 and a support structure 30. The electronic structure 20 has a first surface 21 and a second surface 22 opposite the first surface 21. The support structure 30 has a third surface 31 and a fourth surface 32 opposite to the third surface 31, and the support structure 30 bonds to the second surfaces 22 of the electronic structure 20 by the third surface 31 thereof. The fourth surface 32 of the support structure 30 has a plurality of protrusions 33 arranged in parallel, and a groove 34 is formed between two adjacent protrusions. One or ones of the groove 34 defines an open end 341 and a closed end 342.

The flexible electronic device 10 is bendable, that means both of the electronic structure 20 and the support structure 30 are bendable. For example, the flexible electronic device 10 is capable of rolling or bending about an axis 40, and the flexible electronic device 10 can be transformed between a rolled state and an extended state. To be noted, the axis 40 can be a virtual axis line, or a real central axis, but not limited to. Herein, the axis 40 can be parallel to a short side of the flexible electronic device 10, or parallel to a long side thereof, or parallel to its diagonal, or at any angle to its short side; in other words, the flexible electronic device can roll about any direction and became rolled. It is understandable that the flexible electronic device 10 defines one or more axis for rolling about. In this embodiment, the axis 40 parallels to the short side of the flexible electronic device 10 for illustration (as shown in FIG. 1A which extends from the left side to the right side of the figure, or as shown in FIG. 1B which the direction enters to the figure. In some cases, the electronic structure 20 can be an active matrix (AM) electronic device, or a passive matrix (PM) electronic device, or a detecting device, or a display device, antenna device. As shown in FIG. 1D, the electronic structure 20′, can be a display panel, but not limited thereto. Referring to FIG. 1D, the display panel 20′ can include a supporting layer 23′ and a plurality of display units 24′, in which a side of the supporting layer 23′, ex the second surface 22 connects to the support structure 30; the plurality of the display units 24 are spliced and arranged along another side of the supporting layer 23′ opposite to the support structure 30.

For example, the display unit includes a base substrate, at least one signaling layer, a plurality optoelectronic element, and one or more driving structure. The signaling layer is arranged on or in the base substrate which can form a flexible substrate thereby. The plurality of optoelectronic elements are arranged on the base substrate and electrically connected to the signaling layer, and the one or ones of the driving structures are electrically connected to the signaling layer and the plurality of the optoelectronic elements; wherein the signaling layer can be a signaling patterned layer. The plurality of the optoelectronic elements can be chips or packages, ex the millimeter-scaled chips or packages, micrometer-scaled chips or packages, or nanometer-scaled chips or packages. The optoelectronic element or/and the driving structure include but not limited to a detection chip, a LED chip, a mini chip, and a micro chip; or at least one package, in which the at least one package includes but not limited to chips of millimeter-scaled, micrometer-scaled, nanometer-scaled, or less than nanometer-scaled, wherein a nanometer-scaled can be provided to a micrometer-scaled package. The optoelectronic element or/and the driving structure can also include chiplets with logic operation functions, which sizes thereof is also not limited. The optoelectronic element or/and the driving structure also include diodes (ex. LED, OLED, micro LED, mini LED, and et al), sensing elements, antenna elements or microwave elements. In some cases, the optoelectronic element or/and the driving structure also include ships with horizontal electrode(s), flip-chip electrode(s), or vertical electrode(s). In some cases, the optoelectronic element or/and the driving structure can include active circuit(s) or passive circuit(s). The above-mentioned package in not limited to a package with active element(s) or a passive package without active element(s), the active element includes but not limited to thin-film transistor(s), non-Silicon IC(s) or silicon IC(s). The driving structure can include one or more active elements corresponding to the optoelectronic elements for driving the optoelectronic elements to operate.

The support structure 30 defines a first direction X parallel to the axis 40, a second direction Y perpendicular to the first direction X and parallel to the third surface 31, and a third direction Z perpendicular to the third surface 31. The support structure 30 includes a plurality of protrusions 33 and grooves 34, the protrusions 33 are spaced alone the second direction Y and parallel to the first direction X, and the grooves 34 are formed between two adjacent protrusions 33. One or more of the grooves 34, along the third direction (Z), defines an open end 341 and a closed end 342; in addition, one or more protrusions defines a top 331 along the third direction Z. In some cases, a width of the protrusion along the second direction Y ranges from 0.1 to 5 mm, and the groove 34 defines a width along the second direction Y ranges from 0.1 to 5 mm. In addition, as the flexible electronic device 10 is rolled or bent to a minimum radian, defines a width of the protrusion 33 in the second direction Y as W_{Y}, and defines an arc length of the support structure 30 corresponding to the protrusion 33 as L_{Arc}, and a ration of the W_{Y} to L_{Arc} is less than 1.5, such as 0.9, 1, 1.1 or 1.2, but not limited thereto.

In one case as shown by FIG. 1B, one or ones of the grooves 34 does not penetrate through the support structure 30; in another case as shown by FIG. 1C, one or ones of the grooves 34 penetrate through the support structure 30, and are sealed by the second surface 22, the surface bonds to the support structure 30, of the electronic structure 20.

In some cases, the electronic structure 20 defines a thickness d, and at least one of the plurality of the grooves defines a depth h1, satisfying the following: 3*d≥h1.

In one case, a process to manufacture the support structure comprises: placing a sheet material on the second surface 22 (bottom surface) of the electronic structure 20, and forming or arranging a plurality of grooves 34 or protrusions 33 on a surface of the sheet material opposite to the second surface 22 of the electronic structure 20. For example, the process to form or arrange the protrusions 33 on the surface opposite to the second surface 22 comprises: forming plural protrusions 33, and arranging the plural protrusions 33 spaced on the surface of the sheet material opposite to the second surface 22 of the electronic structure 20 simultaneously or separately, or in batches, and the plural grooves are formed between the protrusions at the same time, to constitute the support structure 30 shown in FIG. 1A and FIG. 1B. In another case, the process to form the plural grooves 34 on the surface of the sheet material opposite to the second surface 22 of the electronic structure 20 includes processing the sheet material by hot melting, laser cutting, or etching to form plural grooves 34, and plural protrusions 33 between the grooves 34 are formed simultaneously, to constitute the support structure 30 shown in FIG. 1A and FIG. 1B.

In some cases, the material(s) of the support structure includes but not limited to polypropylene (PP), polyethylene (PE), resin, or other suitable materials. In some cases, the material of the support structure 30 includes but not limited to metal materials, or other malleable material which can be bent repeatedly. In some cases, the support structure 30 can be a multi-layered structure, can be obtained by combining plural support layers, and the materials of the support layers include but not limited to polypropylene (PP), polyethylene (PE), resin, or other suitable materials, or metal materials, or other malleable material which can be bent repeatedly (ex. nonwoven fabric, steel wires, or other suitable materials).

FIG. 1E is a sectional diagram of another embodiment of this disclosure. The support structure 30″ of the flexible electronic device 10″ in this case further includes a base layer 35 arranged between the protrusions 33 and the electronic structure 20. As shown in FIG. 1E, the plurality of the protrusions are arranged on the base layer 35, and a plurality of grooves 34 are formed between the protrusions 33. In this case, the material of the base layer 35 includes but not limited to a metal layer, or other materials which is thin, malleable, and can be bent repeatedly, such as a metal foil. The material(s) of the base layer 35 and the protrusions 34 can be same or different. In one case, the process to arrange the spaced protrusions 33 on the base layer 35, comprises: forming plural protrusions 33, and arranging the plural protrusions 33 spaced on the base layer 35 simultaneously or separately, or in batches, to constitute the support structure 30″ shown in FIG. 1E. In another case, the process to arrange the spaced protrusions 33 on the base layer 35 comprises: arranging a layer of material on the base layer 35, the material can be the materials of the protrusions 33; process the layer of material by hot melting, laser cutting, or etching to form plural grooves 34, and plural protrusions 33 between the plural grooves 34, to constitute the support structure 30″ in FIG. 1E. To be noted, these cases are only for exemplary but not intense to limit this invention.

Referring to FIG. 1F and FIG. 1G, as the flexible electronic device 10″ is in a rolled state, the closed end 342 of the groove 34 can be a curved surface convex toward to the open end 341, the curved surface defines a height h2 as shown in FIG. 1G. In addition, the flexible electronic device 10″ further includes an adhesion layer 50 between the electronic structure 20 and the support structure 30′ in this case as shown in FIG. 1F. For example, the adhesion layer 50 is arranged between the second surface 22 of the electronic structure 20 and the base layer 35 of the support structure, wherein a thickness of the adhesion layer 50 is greater than the height h2 of the curved surface. In this case, the material(s) of the adhesion layer 50 includes but not limited to optical clear adhesive (OCA), cyclo olefin polymer (COP), thermoplastic elastomer (TPE), polyethylene terephthalate (PET), polypropylene (PP), or other materials can be used as adhesive; in addition, the abovementioned materials is not limited to organic materials.

A row of the protrusion 33 of the support structure 30 of the flexible electronic device 10, can be a continuous strip, or can be constituted by plural subunits, but not limited thereto. As shown in FIG. 1H, as a row of the protrusion 33 is constituted by plural subunits 332, these subunits 332 align to one row to form the protrusion 33, but is not limited thereto.

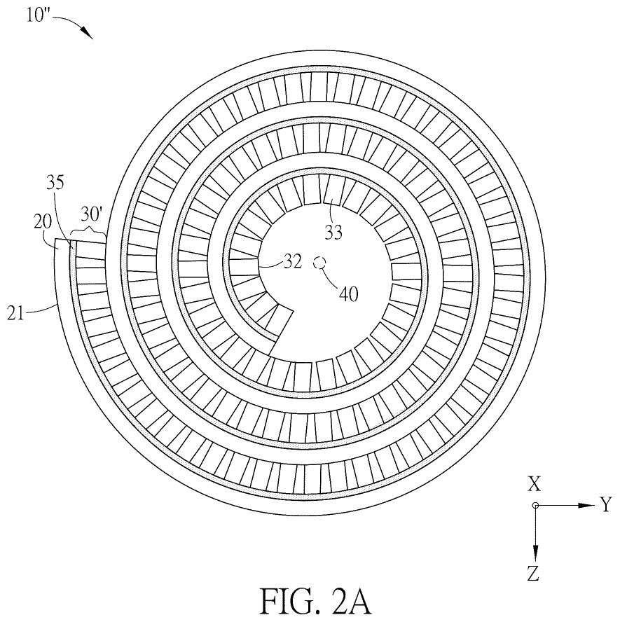

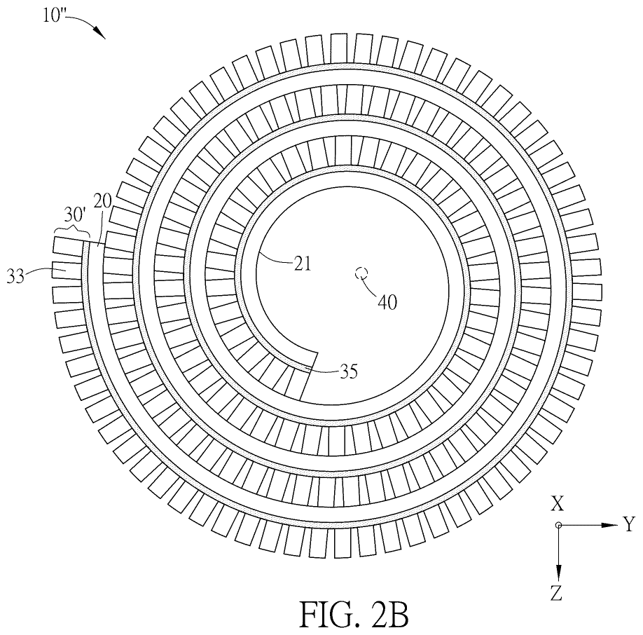

Referring to FIG. 2A and FIG. 2B, the flexible electronic device 10″ can be wound along about the axis 40 into a rolled state. As shown in FIG. 2A, the flexible electronic device 10″ takes the axis 40 as a central axis, and winds along the axis 40 in to a rolled state, the fourth surface 32 of the support structure 30′ faces to the axis 40, add the first surface 21 (ex. display surface) faces to an outer side of the entire rolling structure, this state can be referred as an outward winding state. In one case, the flexible electronic device 10″ is rolled into multiple turns, and a quantity of the protrusions 33 within an innermost turn is defined as M, M≥50. In addition, the minimum winding radius of the flexible electronic device 10″ in one embodiment, ranges from 2.5 cm to 15 cm, or less than 2.5 cm, or ranges from 2.5 cm to 10 cm, or 2.5 cm to 5 cm, ex. 1 cm, 2.5 cm, 5 cm, 10 cm, or 15 cm, but is not limited thereto.

In another case as shown in FIG. 2B, as the flexible electronic device 10″ takes the axis 40 as a central axis, and winds along the axis 40 in to a rolled state, the first surface 21 faces to the axis 40, and the first surface 21 (ex. display surface) faces to the inner side this state can be referred as an inward winding state.

In some cases, a thickness of the flexible electronic device along the third direction Z ranges from 1 mm to 5 mm, or ranges from 1 mm to 2 mm, in which a thickness of the support structure ranges from 0.1 mm to 0.5 mm.

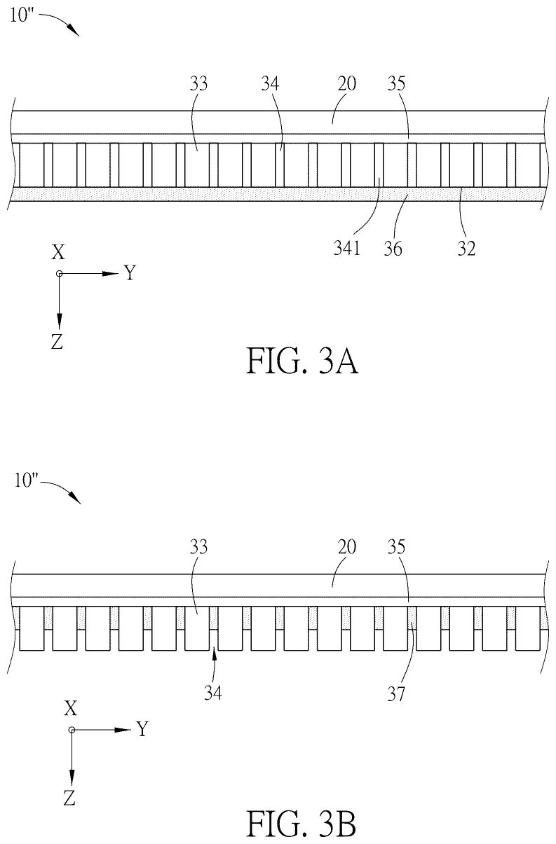

Referring to FIG. 3A, the support structure 30 of the flexible electronic device 10″ further includes an additional layer 36. The additional layer 36 binds to protrusions 33 at the side of the fourth surface 32 of the support structure 30, and the open ends 341 of the grooves 34 are sealed by the additional layer 36. Referring to FIG. 3B, one or more elastic materials or one or more flexible materials 37 is/are provided in the grooves 34 of the support structure 30. These two designs prevent foreign subject(s) falling into the grooves 34, so as to prevent the damage of the flexible electronic device 10″ when rolling or bending from the foreign subject(s).

Accordingly, the flexible electronic device 10 of the present invention enables the supporting structure 30 to provide better structural stability by the design of the protrusion 33 and the channel 34 and retains the bendability at the time, and reduces the risk of structural separation or dislocation.

The following cases are used to describe the structural changes of the flexible electronic device 10 in a rolling state.

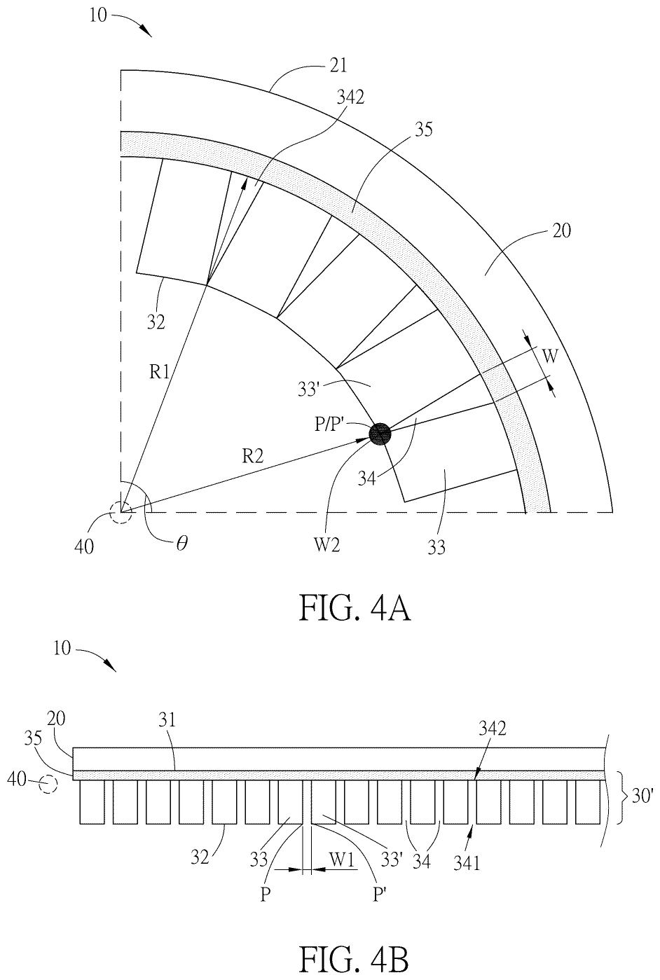

FIG. 4A is a partially enlarged schematic diagram of the flexible electronic device 10″ shown in FIG. 2A. Referring to FIG. 4A, the flexible electronic device 10″ is in a rolled state in which the first surface 21 of the electronic structure 20 faces the outer side and the fourth surface 32 of the support structure 30 faces to the axis 40.

As the flexible electronic device is rolled or bent to a minimum radian, and the two adjacent protrusions 33, 33′ are in the closest state, each of the two adjacent protrusions 33, 33′ defines a closest point P, P′, in which a straight-line distance between the two closest points P, P′ is also the shortest distance between the two adjacent protrusions 33, 33′ as the flexible electronic device is rolled or bent to the minimum radian, is defined as W2. In this case, the shortest distance W2 is zero, which means, which means the two closest points P, P′ can be considered as the contact points of the two protrusions 33, 33′. In addition, a shortest distance between the two adjacent closest point (the two contact points) P, P′ is defined as W1 while the flexible electronic device is in a non-rolled and non-bent state (as shown in FIG. 4B). A shortest distance from the axis 40 to a surface of the base layer or to the closed end 342 of the groove 34 is defined as R1. A shortest distance from the axis 40 to one of the closest point (the contact point in this case) as the flexible electronic device is rolled or bent to a minimum radian is defined as R2. A corresponding angle of the roll part or the bent part of the support structure 30 to the axis 40 is defined as θ degrees, as the flexible electronic device is rolled or bent. And, a quantity of the protrusions 33 located in the rolled part or bent part of the support structure 30 is N (so the quantity of the grooves 34 is N or N−1). In this case the two closest points (the contact points P, P′ in this case) of the two protrusions 33, 33′ are located near the open end 341 of the groove 34.

Meanwhile, an arc length of the surface of the base layer 35 in a rolled state can be obtained by equation I:

$$2 π * R 1 * θ / 360 ° \qquad equation I$$

An arc length of a virtual arc line formed by connecting the plural closest points of the plural sets of protrusions can be obtained by equation II:

$$2 π * R 2 * θ / 360 ° \qquad equation II$$

Further, a distance between the closest point (contact point P) to the closed end 342 of the groove 34 is approximately to a deference between the shortest distance R1 between the axis 40 and the closed end 342 of the of the groove, and the shortest distance R2 between the axis and the closest point (the contact point P) of the protrusion 33, which is R1 minus R2.

Therefore, a difference between the arc length of the surface of the base layer 35, and the arc length of a virtual arc line formed by connecting the plural closest points of the plural sets of protrusions, is approximately to a sum of the shortest distance W1 of the two closest points (contact points) of a set of the protrusions as the flexible electronic device 10 in a non-rolled and non-bent state within the rolled or bent part (which is N*W1 or (N−1)*W1), therefore, an equation IV or an equation V is obtained as follows:

$$W 1 = \{ [ ( 2 π * ( R 1 ) - ( 2 π * ( R 2 ) ] * θ / 360 ° \} / ( N - 1 ) \qquad equation IV$$

$$W 1 = \{ [ ( 2 π * ( R 1 ) - ( 2 π * ( R 2 ) ] * θ / 360 ° \} / N \qquad equation V$$

Therefore, an equation VI is obtained as follows:

$$W 1 \geq [ ( 2 π * ( R 1 - R 2 ) ] * θ / 360 ° / N \qquad equation VI$$

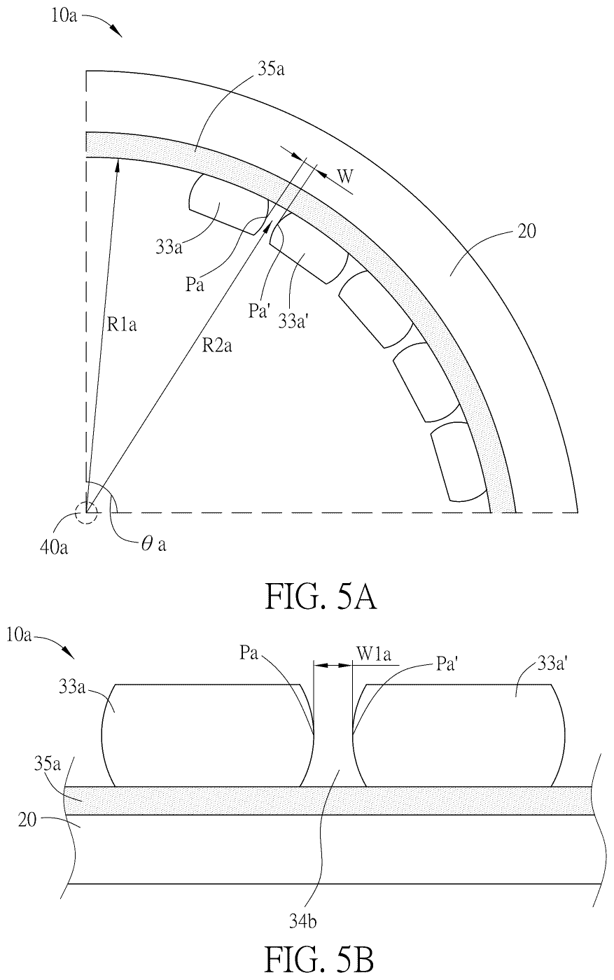

Referring to FIG. 5A and FIG. 5B, the protrusion 33a of the support structure 30a of the flexible electronic device 10a has a wider middle part, so the closest points Pa, Pa′ of two adjacent protrusions 33a, 33a′ are located at the wider middle part as the flexible electronic device 10a is rolled or bent to a minimum radian and the two adjacent protrusions 33a, 33a′ are in a closest state. Referring to FIG. 5B, a shortest distance between the two closest points Pa, Pa′ as the flexible electronic device 10a in a non-rolled and non-bent state is W1a. In addition, the shortest distance from the axis 40a to a surface of the base layer 35a (or to the closed end 342 of the groove 34) is R1a, and the shortest distance from the axis 40a to one of the closest point Pa is R2a. The corresponding angle of the roll part or the bent part of the support structure 30a to the axis 40a is defined as θa degrees, as the flexible electronic device is rolled or bent, and the quantity of the protrusions located in the rolled part or bent part of the support structure 30 is N (the quantity of the grooves 34 is N or N−1), also satisfying the abovementioned equation VI.

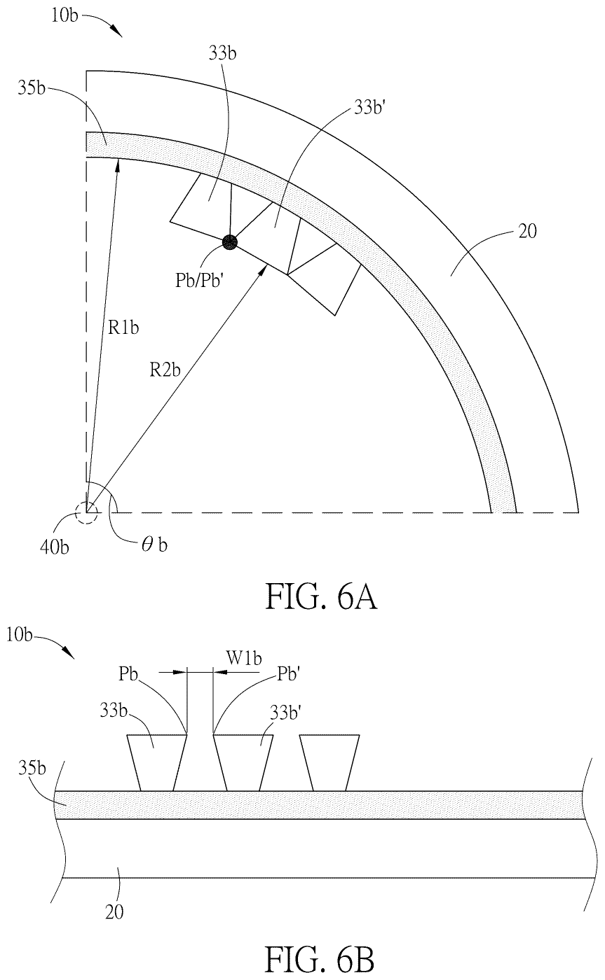

Another embodiment is illustrated in FIG. 6A and FIG. 6B. In this case, the protrusion 33b of the support structure 30b has a widest part at the location away from the base layer 35b of the support structure 30b. So, the closest points Pb, Pb′ of the two adjacent protrusions 33b, 33b′ will be located at a farthest location away from the base layer 35, as the flexible electronic device 10b is rolled or bent to a minimum radian and the two adjacent protrusions 33b, 33b′ are in a closest state. Referring to FIG. 5B, a shortest distance between the two closest points Pb, Pb′ as the flexible electronic device 10b in a non-rolled and non-bent state is W1b. In addition, the shortest distance from the axis 40b to a surface of the base layer 35b (or to the closed end 342 of the groove 34b) is R1b, and the shortest distance from the axis 40b to one of the closest point Pb is R2a. The corresponding angle of the rolled part or the bent part of the flexible electronic device10b to the axis 40b is defined as θb degrees, as the flexible electronic device 10b is rolled or bent, and the quantity of the protrusions 33b located in the rolled part or bent part of the support structure 30b is N (the quantity of the grooves 34 is N or N−1), also satisfying the abovementioned equation VI.

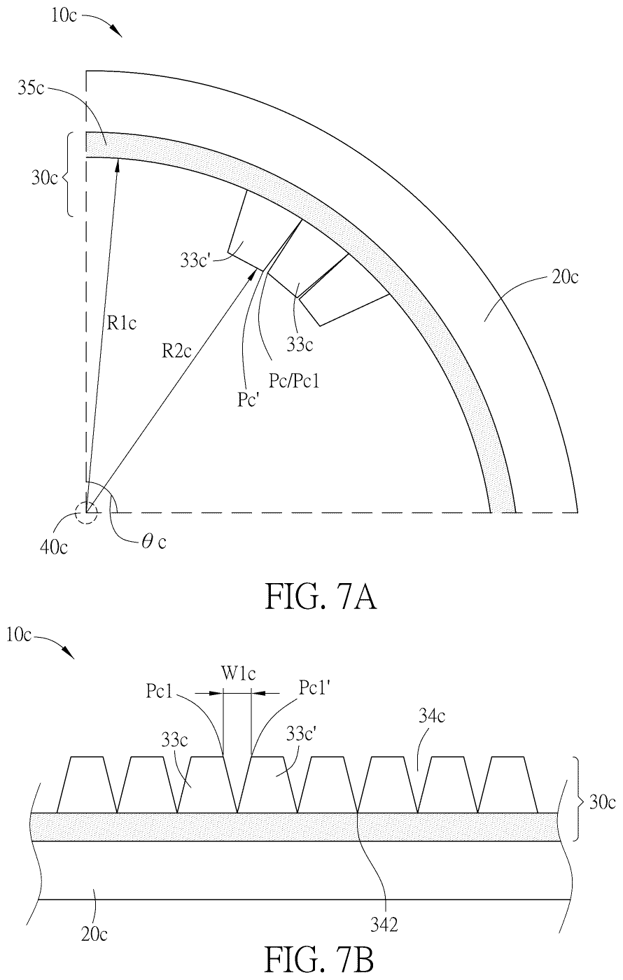

FIG. 7A and FIG. 7B show another embodiment of this invention. In this case, a cross-section of the protrusion 33c or the support structure 30b has a trapezoid-like shape, and two sides of adjacent protrusions are almost contacted completely when the flexible electronic device 10c is rolled or bent to a minimum radian. Therefore, the two adjacent protrusions 33c, 33c′ have a plurality sets of corresponding closest points Pc, Pc′, and one set of the closest points Pc1, Pc1′ is located at a farthest location from the base layer 35c of the support structure 30c. In this case, the shortest distance R1c between the axis 40c and a surface of the base layer 35c (or the closed end 342 of the of the groove 34c), the shortest distance R2 between the axis 40c and the closest points Pc1, or Pc1′ of the protrusion 33c, the shortest distance W1c of this set of the closest points Pc1 and Pc1′ as the flexible electronic device 10c in a non-rolled or non-bent state, and the shortest distance W2c between the two adjacent protrusions 33, 33′ as the flexible electronic device 10c is rolled or bent to the minimum radian are defined, which also satisfy the equation VI.

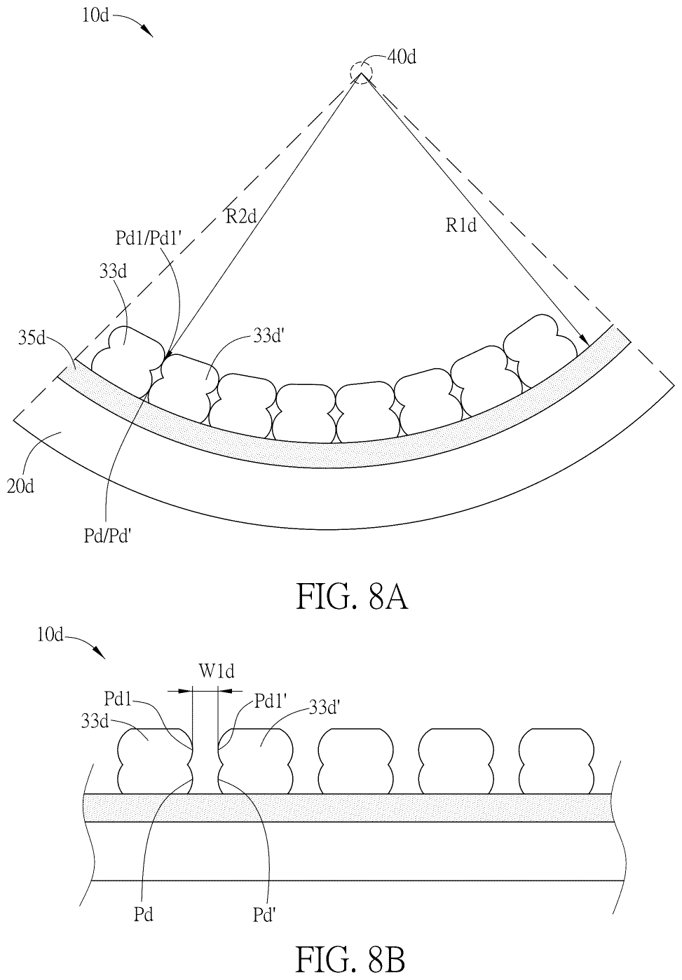

In the embodiment shown in FIG. 8A and FIG. 8B, the protrusions 33d of the support structure 30d has at least two sets of the closest points when the flexible electronic device 10d is rolled or bent into a minimum radian, and the closes points of two adjacent protrusions 33d, 33d′ also contacts to each other in this case and can be considered as contact points. In this case, a plurality of corresponding closest points Pd, Pd′ are also provided to the two adjacent protrusions 33d, 33d′. One set of the closest points Pd1, Pd1′ is located at a farthest location of the protrusions 33d, 33d′ away from the base layer 35d of the support structure 30d. In this case, the shortest distance R1d between the axis 40d and a surface of the base layer 35d (or to the closed end 342 of the of the groove 34d), the shortest distance R2d between the axis 40d and the closest points Pd1 or Pd1′ of the protrusion 33d or 33d′, the shortest distance W1d of this set of the closest points Pd1 and Pd1′ as the flexible electronic device 10d in a non-rolled and non-bent state, and the shortest distance W2d between the two adjacent protrusions 33d, 33d′ as the flexible electronic device 10d is rolled or bent to the minimum radian are defined, which also satisfy the equation VI.

In some cases, when the flexible electronic device on the present invention is rolled or bent to a minimum radian, and the two adjacent protrusions are in a closest state, the closest points of the two adjacent protrusions, is also a closest location of these two adjacent protrusions when the flexible electronic device is in a non-rolled or non-bent state, in which this location is also the narrowest part of the groove between the two adjacent protrusions, but is not limited thereto.

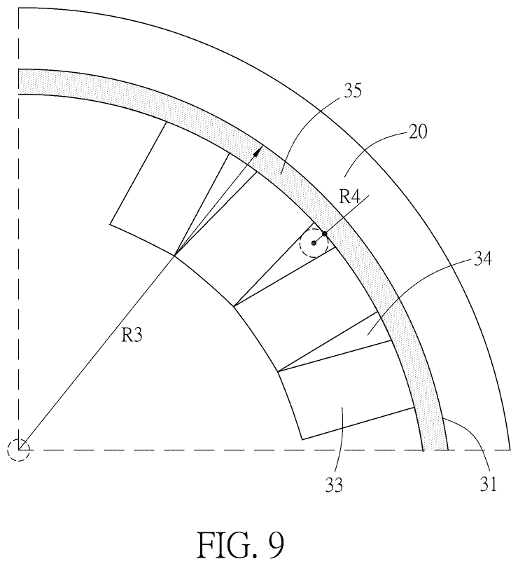

Referring to FIG. 9, as the flexible electronic device is rolled or bent to a minimum radian, and two adjacent protrusions 33 are in a closest state, a radius of curvature of the third surface 31 located in the rolled part or bent part of the support structure 30 is defined as R3, and a radius of curvature of the closed end 342 of the groove(s) 34 located in the rolled part or bent part of the support structure 30 is defined as R4, which satisfy the following condition: R4≥R3/3.

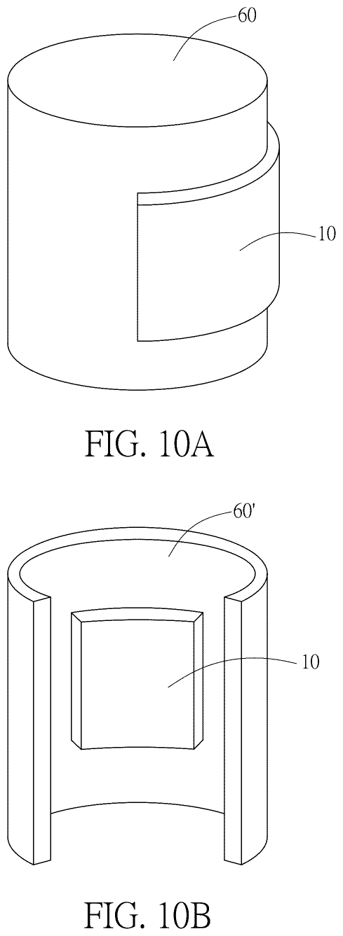

Further, as shown in FIG. 10A and FIG. 10B, the flexible electronic device 10 can be arranged on a non-flat surface, ex. on a surface of a cylinder 60, or a surface of an arc shell 60′, or a non-regular curved inner surface or outer surface of a wall.

According to the above descriptions, the flexible electronic device of this invention is capable rolling about the axis, so the flexible electronic device can be transformed between a rolled state and an extent state; the flexible electronic device comprises an electronic structure and a support structure; the electronic structure has a first surfaces and a second surface opposite to each other; the support structure has a third surface and a fourth surface opposite to each other, and the third surface of the support structure bonds to the second surface of the electronic structure. The support structure defines a first direction parallel to the axis, and a second direction perpendicular to the first direction and parallel to the third surface; the fourth surface of the support structure has a plurality of protrusions spaced along the second direction and parallel to the first direction, and a plurality of grooves formed between two adjacent protrusions; one or ones of the grooves defines an open end and a closed end. The flexible electronic device 10 of the present invention enables the supporting structure 30 to provide better structural stability by the design of the protrusion 33 and the channel 34 and retains the bendability at the time, and reduces the risk of structural separation or dislocation.

What is claimed is:

1. A flexible electronic device, capable of rolling or bending about an axis, comprising:
an electronic structure having a first surface and a second surface opposite each other; and
a support structure having a third surface and a fourth surface opposite to each other, wherein the supporting structure bonds to the second surfaces of the electronic structure by the third surface thereof; the support structure defines a first direction parallel to the axis, a second direction perpendicular to the first direction and parallel to the third surface, and a third direction perpendicular to the third surface;
wherein the fourth surface of the support structure has a plurality of protrusions spaced in the third direction and parallel to the first direction, and a plurality of grooves formed between two adjacent protrusions; one or ones of the grooves, along the third direction, defines an open end and a closed end, and defining a shortest distance between the axis and the closed end as R1 as the flexible electronic device rolled or bent to a minimum radian;
wherein two adjacent protrusions respectively defines a closest point as the flexible electronic device rolled or bent to a minimum radian and the adjacent two protrusions are in the closest state, in which a straight-line distance between the two closest points is the shortest distance between the two adjacent protrusions, defining a shortest distance from the axis to one of the closest point as R2, and defining a shortest distance between the two adjacent closest point is as W1 while the flexible electronic device is in a non-rolled and non-bent state; and
wherein as the flexible electronic device is rolled or bent to a minimum radian, defining a corresponding angle of the roll part or the bent part thereof to the axis as θ degrees, and a quantity of the protrusions located in the rolled part or bent part of the support structure is N, satisfying the following condition
$$W 1 * N \geq 2 * π * ( R 1 - R 2 ) * θ / 360 ° .$$

2. The flexible electronic device as claimed in claim 1, wherein the straight-line distance between the two closest points is the shortest distance between the two adjacent protrusions is defined as W2 while the flexible electronic device is rolled or bent to a minimum radian and the adjacent two protrusions are in the closest state, and W2≥0.

3. The flexible electronic device as claimed in claim 1, wherein the support structure comprises a base layer between the plurality or protrusions and the electronic structure.

4. The flexible electronic device as claimed in claim 3, wherein the material of the base layer is different from the material of the plurality of the protrusions.

5. The flexible electronic device as claimed in claim 1, further comprising an adhesion layer between the electronic structure and the support structure.

6. The flexible electronic device as claimed in claim 5, wherein the closed end of the groove is a curved surface convex toward to the open end of the groove and defines a height of the curved surface as the flexible electronic device is in a rolled or a bent state, and a thickness of the adhesion layer is greater than the height of the curved surface.

7. The flexible electronic device as claimed in claim 1, wherein the electronic structure comprises a display panel.

8. The flexible electronic device as claimed in claim 1, wherein the electronic structure defines a thickness d, and one or ones of the grooves defines a depth h1, satisfying the condition:
3*d≥h1.

9. The flexible electronic device as claimed in claim 1, further comprising an additional layer bonding to a side of the plurality of the protrusions away from the support structure and sealing the open ends of the plurality of the protrusions.

10. The flexible electronic device as claimed in claim 1, wherein one or more of the protrusions is constituted by one or more subunits.

11. The flexible electronic device as claimed in claim 1, wherein the third surface of the support structure within at least a section of continuous grooves defines a radius of curvature R3, and the closed end of the at least one of the grooves within the at least part of continuous grooves of the support structure defines a radius of curvature R4 as the flexible electronic device is rolled or bent into a minimum radian, and satisfying the following:
R4≥R3/3.

12. A flexible electronic device, capable of rolling or bending about an axis, comprising:
an electronic structure having a first surface and a second surface opposite each other; and
a support structure having a third surface and a fourth surface opposite to each other, wherein the supporting structure bonds to the second surfaces of the electronic structure by the third surface thereof, the support structure defines a first direction parallel to the axis, a second direction perpendicular to the first direction and parallel to the third surface, and a third direction perpendicular to the third surface, the fourth surface of the support structure has a plurality of protrusions spaced in the third direction and parallel to the first direction, and a plurality of grooves formed between two adjacent protrusions; one or ones of the grooves, along the third direction, defines an open end and a closed end;
wherein the third surface of the support structure within at least a section of continuous grooves defines a radius of curvature R3, and the closed end of the at least one of the grooves within the at least part of continuous grooves of the support structure defines a radius of curvature R4 as the flexible electronic device is rolled or bent into a minimum radian, and satisfying the following:
R4≥R3/3.

13. The flexible electronic device as claimed in claim 12, wherein the support structure comprises a base layer between the plurality or protrusions and the electronic structure.

14. The flexible electronic device as claimed in claim 13, wherein the material of the base layer is different from the material of the plurality of the protrusions.

15. The flexible electronic device as claimed in claim 12, further comprising an adhesion layer between the electronic structure and the support structure.

16. The flexible electronic device as claimed in claim 15, wherein the closed end of the groove is a curved surface convex toward to the open end of the groove and defines a height of the curved surface as the flexible electronic device is in a rolled or a bent state, and a thickness of the adhesion layer is greater than the height of the curved surface.

17. The flexible electronic device as claimed in claim 12, wherein the electronic structure defines a thickness d, and one or ones of the grooves defines a depth h1, satisfying the condition:
3*d≥h1.

18. The flexible electronic device as claimed in claim 12, further comprising an additional layer bonding to a side of the plurality of the protrusions away from the support structure and sealing the open ends of the plurality of the protrusions.

19. The flexible electronic device as claimed in claim 12, wherein one or more of the protrusions is constituted by one or more subunits.

20. The flexible electronic device as claimed in claim 12, wherein the electronic structure comprises a display panel.
